(19) United States
(12) Patent Application Publication
(10) Pub. No.: US 2026/0238660 A1
(43) Pub. Date: Aug. 13, 2026

(54) COMPROMISE DETECTION CONSISTENCY

(71) Applicant: Abnormal Security Corporation, Las Vegas, NV (US)

(72) Inventors: Sanjay Jeyakumar, El Cerrito, CA (US); Abhijit Bagri, Atlanta, GA (US); Tanooj Vipul Parekh, Mountain View, CA (US); Yu Zhou Lee, San Francisco, CA (US); Daniel Shiebler, San Francisco, CA (US); Sheng Yuan Jethro Kuan, Jersey City, NJ (US); Ashley D. Li, Vancouver (CA); Kourosh Banaeianzadeh, Calgary (CA)

(21) Appl. No.: 19/049,931

(22) Filed: Feb. 10, 2025

(51) Int. Cl. H04L 9/40

(52) U.S. Cl. CPC H04L 63/1425; H04L 63/1416

(57) ABSTRACT

Indicators of compromise signatures of previously received messages are tracked in a data storage. A new message having indicators is received. Using a machine learning model, a determination is made whether the new message is suspicious. Based on a result of the machine learning model for the new message, the new message is assigned a security classification. The data storage is searched to determine whether the indicators of the new message match any of the tracked indicators of compromise signatures determined to be suspicious. The security classification of the new message is revised to match a tracked security classification of a previously received message having a matching tracked indicators of compromise signature with the new message.

### BACKGROUND OF THE INVENTION

Threat detection systems can identify suspicious messages and perform security actions to mitigate identified threats. For example, suspicious messages can be moved to a quarantine folder to limit a user's access to them. Traditionally, a threat detection system analyzes each message individually, and a threat determination is made for each message. As a result, threat assessments for similar or identical threats can lead to inconsistent detection results and potential knowledge gaps in the security landscape. Therefore, there is a need for greater consistency in message threat detection, particularly when addressing malicious and compromised messages.

### BRIEF DESCRIPTION OF THE DRAWINGS

Various embodiments of the invention are disclosed in the following detailed description and the accompanying drawings.

FIG. 1 is a block diagram illustrating an embodiment of a threat detection system that maintains consistency in threat detection outcomes.

FIG. 2 is a block diagram illustrating an embodiment of a threat detection system that maintains consistency in threat detection outcomes.

FIG. 3 is a flow chart illustrating an embodiment of a process for performing threat detection that maintains consistency in threat detection outcomes.

FIG. 4 is a flow chart illustrating an embodiment of a process for identifying a message that poses as a security threat and initiating remediation actions.

FIG. 5 is a flow chart illustrating an embodiment of a process for identifying a message that poses as a security threat using message indicators.

FIG. 6 is a flow chart illustrating an embodiment of a process for identifying a message as a security threat using indicators of compromise signatures.

FIG. 7 is a flow chart illustrating an embodiment of a process for identifying a new security threat using a message threat threshold.

FIG. 8 is a functional diagram illustrating a programmed computer system for performing threat detection that maintains consistency in threat detection outcomes.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Compromise detection consistency is disclosed. Using the disclosed systems and techniques, consistency in compromise detection results when evaluating messages for threats is maintained. For example, when analyzing messages, such as email messages, for potential threats, the disclosed threat detection system utilizes the disclosed techniques to maintain uniformity in threat detection outcomes. The employed approaches ensure that messages with the same, similar, or related threats are identified and addressed with consistent security actions, including similar threat warnings and resolutions. For example, messages sent to different enterprise users as part of the same coordinated phishing campaign are recognized as related and treated as part of the same attack campaign. When security personnel review the identified threats, the compromised messages are displayed with consistent threat detection results, such as with identical warning messages and resolutions.

In traditional threat detection systems, identical attacks delivered via different messages often result in varying security threat responses, including inconsistent warning messages. Such inconsistencies can create confusion and undermine trust in the threat detection system and its accuracy, particularly among end users but also with security personnel. By contrast, the disclosed threat detection system ensures that similar and related attacks are handled consistently, including by performing retrospective analyses of previously received messages to revise prior threat detection results. In various embodiments, the disclosed system aligns the security classification results for past, present, and future messages.

As disclosed herein, the compromise detection consistency techniques and systems can be used to implement both full and partial consistency solutions. Depending on the employed approach, the threat detection results may yield different outcomes. For example, with a full consistency approach, all messages that share the same signature receive the same decision. This approach prioritizes full consistency in outcomes over potential message-level false positives, where the message-level false positives can be resolved by improving the evaluation of the original false positive. In contrast, with a partial consistency approach, only a subset of the messages that share the same signature receive the same decision. Instead of enforcing full consistency, false negatives are used to improve and detect future attacks. The identified signatures correspond to indicators of maliciousness and are used to improve detection results.

In some embodiments, a data store is utilized to track the signatures of suspicious messages. The tracked signatures, which correspond to different indicators of message compromise, are used to maintain consistency in threat detection. For example, when new messages are analyzed, if the signature of a new message matches a tracked signature of a compromised message, the disclosed threat detection system classifies the new message with the same (or similar) security classification that is associated with the tracked signature. In some embodiments, the message indicators used to track the indicators of compromise signatures for compromised messages can include components or fields of a message such as a message's message-id (or Internet Message ID or IMID), message group ID, Internet Protocol (IP) address, and subject. Additional indicators can include message sender, reply-to, links, and attachments, among others including other message header fields. In some embodiments, the values stored for the indicators may be digest or compressed values such as a digest of an attachment rather than storing an entire email attachment. In some embodiments, the sender and/or reply-to indicators can include relative domain name (RDN), fully qualified domain name (FQDN), and email components.

In some embodiments, indicators of compromise signatures of previously received messages are tracked in a data storage. For example, past messages that have been evaluated and identified as threats are stored in a data store by their signatures. The tracked and stored signatures correspond to indicators of compromise signatures and are based on different indicators of the past messages. The indicators of a message can include components or fields of a message such as a message's message-id, message group ID, IP address, subject, sender, reply-to, links, and attachments, among others including other message header fields. For an attachment, the indicator value can be a digest of the attachment rather than the full attachment.

In some embodiments, a new message having indicators is received. For example, for each new message that is received, indicators of the message are extracted and used to evaluate the message to determine whether the message is a potential threat. The indicators of a new message can include components or fields of the received message such as a message's message-id, message group ID, IP address, subject, sender, reply-to, links, and attachments, among others including other message header fields.

In some embodiments, a machine learning model is used to determine whether the new message is suspicious. For example, the new message is evaluated using a machine learning model trained to score messages based on a threat assessment. In various embodiments, a predicted threat score is used to identify compromised messages as suspicious. Messages identified as suspicious are potential threat candidates and potentially malicious messages that require remediation. In some embodiments, all messages identified as suspicious are treated as malicious and/or as a security threat. In some embodiments, based on a result of the machine learning model for the new message, the new message is assigned a security classification. For example, a security classification is assigned to each new message identified as suspicious. The security classification can be used to remediate the message's threat including by providing the appropriate warning messages and/or initiating the appropriate remediation actions. Although a security classification assigned without concern to compromise detection consistency may and likely will result in the correct result from a security perspective, it is often critical to have consistency in compromise detection such that the same messages are grouped to the same assigned security classification. This consistency is particularly important when managing large scale threats, providing security personnel essential information and providing a clear view of different attack campaigns including different attack vectors.

In some embodiments, the data storage is searched to determine whether the indicators of the new message match any of the tracked indicators of compromise signatures determined to be suspicious. For example, the indicators extracted from the new message are compared against signatures of messages previously identified as suspicious. The tracked signatures are made up of different indicators of compromise such as specific values for different indicators such as message-id, message group ID, IP address, subject, sender, etc. In some embodiments, a match is found using exact matches. For certain indicators, such as a message subject field, non-exact matches including fuzzy matches, partial or full keyword matches, regular expression matches, etc. may also be appropriate.

In some embodiments, the security classification of the new message is revised to match a tracked security classification of a previously received message having a matching tracked indicators of compromise signature with the new message. For example, the initial security classification assigned based on the machine learning model result is revised to ensure compromise detection consistency. Instead, the message is assigned the security classification of a tracked security classification with the indicators of compromise signature that matches the new message's indicators. By revising the security classification, the consistency in the threat assessment outcome for message of the same threat is maintained, and discrepancies where two different security classifications are provided for the same or similar attack are prevented. In some embodiments, a consensus resolution process is used to evaluate the different outcomes in security classification and to select a single decision to apply across all messages matching the same signature.

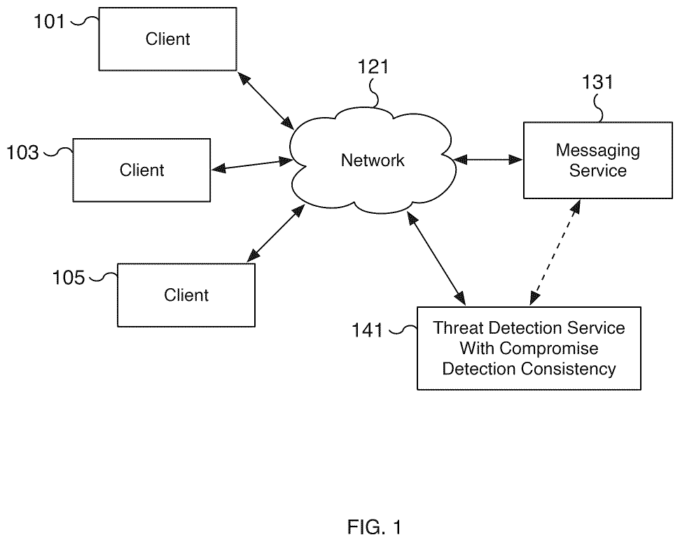

FIG. 1 is a block diagram illustrating an embodiment of a threat detection system that maintains consistency in threat detection outcomes. In the example shown, messages provided via messaging service 131 for clients such as clients 101, 103, and 105 are analyzed for threats by threat detection service with compromise detection consistency 141. Clients 101, 103, and 105 are communicatively connected to messaging service 131 and/or threat detection service with compromise detection consistency 141 via network 121. Similarly, threat detection service with compromise detection consistency 141 is communicatively connected to messaging service 131 via network 121. Network 121 can be a public or private network. In some embodiments, network 121 is a public network such as the Internet. In various embodiments, clients such as clients 101, 103, and/or 105 can access messaging service 131 to fulfill messaging requirements such as sending and receiving messages. Threat detection service with compromise detection consistency 141 monitors and analyzes the messages, identifying and mitigating threats posed by suspicious messages. In some embodiments, threat detection service with compromise detection consistency 141 accesses messages for a monitored client by directly accessing messaging service 131 for messages on behalf of the client and/or by directly accessing messages on the client, such as by directly accessing a message application running on a client such as client 101, 103, or 105.

In various embodiments, the threat detection outcomes identified by threat detection service with compromise detection consistency 141 are aligned for consistent outcomes. This ensures that messages with the same, similar, or related threats are identified and addressed with consistent security actions, including similar threat warnings and resolutions. Compromise detection consistency is met by tracking indicators of compromise for messages identified as suspicious, and tracking the indicators of each suspicious message using an indicators of compromise signature. In various embodiments, the monitoring and actions performed by threat detection service with compromise detection consistency 141 can be presented as reports. Example reporting mechanisms can include email reports, notifications, and online interactive reports such as via a dashboard.

In some embodiments, clients 101, 103, and 105 are each a network client device for interfacing with messaging service 131 and/or threat detection service with compromise detection consistency 141. For example, clients 101, 103, and/or 105 can correspond to users of an organization configured to access a messaging service such as an email service offered by messaging service 131. As another example, clients 101, 103, and/or 105 can correspond to information security personnel or other users with authorized security credentials that utilize threat detection service with compromise detection consistency 141 for performing security responsibilities, including managing threat detection for supported messaging services such as messaging service 131. For example, clients corresponding to an authorized security administrator can configure threat detection service with compromise detection consistency 141 and/or access threat detection reports from threat detection service with compromise detection consistency 141. In some embodiments, clients 101, 103, and/or 105 can further correspond to one or more compromised clients capable of sending malicious messages via messaging service 131.

In some embodiments, messaging service 131 is a cloud-based platform for providing messaging services. Examples of messaging services can include email, group or workplace chat or communication services, text and/or multimedia messaging services, and instant messaging services, among others. Although only a single messaging service 131 is shown in FIG. 1, multiple messaging services can be supported, such as different email services and/or one or more email services along with other messaging services, such as a group chat service. In various embodiments, messages sent via messaging service 131 are analyzed for potential threats by threat detection service with compromise detection consistency 141.

In some embodiments, threat detection service with compromise detection consistency 141 is a threat detection system for detecting and mitigating threats associated with suspicious messages or messages that pose a security threat. For example, threat detection service with compromise detection consistency 141 can ingest messages sent and/or received by messaging service 131. In some embodiments, the messages are retrieved from messaging service 131 and/or by directly accessing the messages from clients. The messages are analyzed, and those messages that pose a potential security threat (and are therefore likely malicious) are identified as suspicious. In some embodiments, messages are identified by scoring a message with a machine learning model trained to detect suspicious messages and predicting a security classification. In addition to applying deep learning techniques for threat detection, the messages can also be compared against messages previously identified as suspicious based on matching message indicators to tracked indicators of compromise signatures. To enforce compromise detection consistency, messages identified as suspicious via the machine learning approach are revised to have the same security classification as a compromised message with the matching indicators of compromise signature. In various embodiments, the enforcement of compromise detection consistency can be performed retrospectively and prospectively to align the security classification results for past, present, and future messages. For example, a configurable lookback window can be applied to previously received messages that match a signature and a forward-looking time-to-live window can be applied for future matching messages.

In various embodiments, threat detection service with compromise detection consistency 141 can further provide reports on threat detection results to users such as security personnel. For example, threat detection service with compromise detection consistency 141 can provide automated reports including notifications and/or email reports based on detected threats and attack campaigns. The provided reports can aggregate results across multiple messages including messages for an entire organization and/or associated with different users. When aggregated, the impact of compromise detection consistency is very apparent, as messages belonging to the same attack campaign will be shown grouped together such as with the same security classification. When campaign consistency is not supported, similar and related messages or even the same message evaluated at different times can be shown with inconsistent security outcomes including different security classifications. In some embodiments, threat detection service with compromise detection consistency 141 provides a dashboard such as an interactive dashboard for reviewing and managing detected threats including for reviewing threats based on the attack, by a security and/or threat campaign, and/or by security classification, among other grouping or filters.

Although single instances of some components have been shown to simplify the diagram of FIG. 1, additional instances of any of the components shown in FIG. 1 may exist. For example, messaging service 131 may be implemented by one or more messaging service servers and threat detection service with compromise detection consistency 141 may be similarly implemented by one or more threat detection service servers. Additionally, clients 101, 103, and 105 are example client devices. Although three clients are shown (clients 101, 103, and 105), many more additional clients can exist. Similarly, although only a single messaging service is shown (digital messaging service 131), many more messaging services can be supported and monitored by threat detection service with compromise detection consistency 141. In some embodiments, components not shown in FIG. 1 may also exist and/or the network configuration of the included components may differ from what is shown.

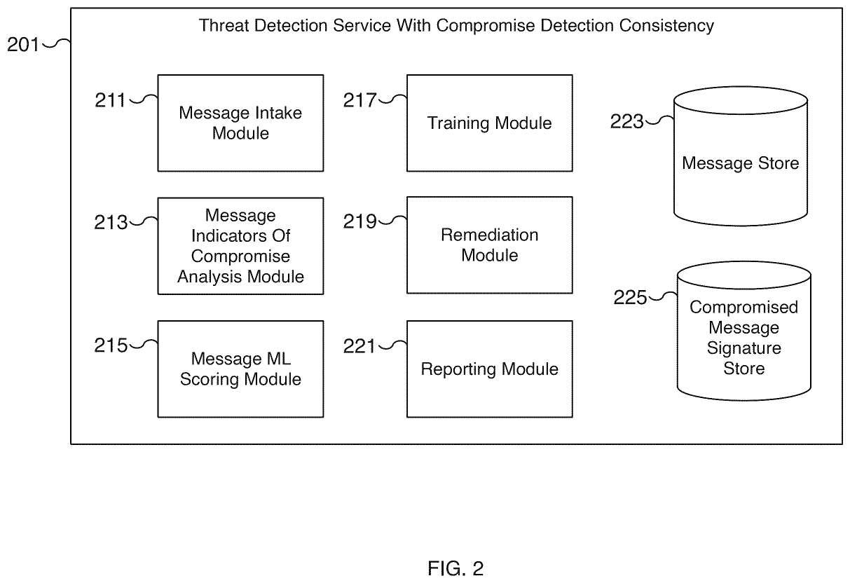

FIG. 2 is a block diagram illustrating an embodiment of a threat detection system that maintains consistency in threat detection outcomes. In the example shown, threat detection service with compromise detection consistency 201 includes message intake module 211, message indicators of compromise analysis module 213, message machine learning (ML) scoring module 215, training module 217, remediation module 219, reporting module 221, message store 223, and compromised message signature store 225. When configured for detecting suspicious messages that may be security threats, threat detection service with compromise detection consistency 201 identifies messages that are suspicious by determining a security classification using an ML model, and for identified suspicious messages, compares the message against tracked signatures for compromised messages. When a message identified as suspicious also matches a tracked signature associated with a known compromised message, the security classification of the identified suspicious message is revised to match the known compromised message. In this manner, threat detection outcomes for the same, similar, and/or related messages are consistent. For example, messages originating from the same attack campaign can be identified as belonging to the same campaign and addressed in a uniform manner. In some embodiments, threat detection service with compromise detection consistency 201 is threat detection service with compromise detection consistency 141 of FIG. 1 and the messages analyzed for threats are serviced by messaging service 131 of FIG. 1.

In some embodiments, message intake module 211 is a processing module for ingesting messages associated with a messaging service for analysis. For example, message intake module 211 can be configured to retrieve messages associated with a user (such as a user associated with an enterprise) to initiate the analysis of the retrieved messages for security threats. In some embodiments, message intake module 211 connects directly (such as via a provided application programming interface) with a messaging service such as messaging service 131 of FIG. 1. In some embodiments, message intake module 211 connects directly with clients of the messaging service such as messaging applications running on clients 101, 103, and/or 105 of FIG. 1. Message intake module 211 can be configured with the proper settings and authorization to retrieve and modify messages. For example, when a retrieved message is identified as a security threat, security actions including remediation actions can be performed. In various embodiments, message intake module 211 can be configured to function with multiple different messaging services and platforms and interfaces with one or more of the other processing modules of threat detection service with compromise detection consistency 201 to perform message threat detection, mitigation, and remediation while maintaining uniform and consistent threat detection outcomes.

In some embodiments, for each newly received and/or analyzed message, a version of the message is stored such as in message store 223. By storing the message, the message can be potentially retrieved at a later date such as when new threats are identified. For example, when a new threat is identified, previously analyzed messages can be retrospectively analyzed to determine whether they match the new threat. In various embodiments, the messages are stored using a compressed version of the message such as a digest version of the message. In some embodiments, the messages are stored by storing the values of extracted message indicators along with additional message metadata.

In some embodiments, message indicators of compromise analysis module 213 is a processing module for analyzing message indicators for matching indicators of compromise. For example, for a received message ingested via message intake module 211, such as an email message or another type of message, message indicators of compromise analysis module 213 can analyze the message to extract message indicators and then compare the values of the extracted indicators to tracked signatures associated with known compromised messages. The tracked signatures are indicators of compromise signatures and can be composed of a set of indicators with specific values, such as specific values for a set of message-id, message group ID, an IP address, sender, and subject values. In various embodiments, indicators for a message can include components or fields of the message such as a message's message-id, message group ID, IP address, subject, sender, reply-to, links, and attachments, among others including other message header fields. In some embodiments, the values extracted for the indicators may be representative values, such as a digest value of an attachment. Utilizing a representative or digest value allows for the comparison of a message's indicator to a known compromised message's corresponding indicator without using a full indicator value, which can be significantly large for attachments.

In some embodiments, message indicators of compromise analysis module 213 can determine whether a new message and its indicators match a known and tracked indicators of compromise signature. The known indicators of compromise signatures can be tracked and stored in a data store such as compromised message signature store 225 along with a corresponding security classification. When a match is found, the stored security classification can be appropriately applied to the new message. By applying the same security classification used for the matching message, compromise detection consistency is ensured.

In some embodiments, message indicators of compromise analysis module 213 is utilized to analyze new messages to identify and track new threats. For example, message indicators of compromise analysis module 213 can be used to identify certain security threats such as denial of service (DOS) attacks. When tracked values such as message count values exceed one or more configured threshold values, a new threat (such as a DOS attack) is detected, and the corresponding message is identified as suspicious. The indicators of the message identified as suspicious can be stored and tracked as a new indicators of compromise signature. In some embodiments, the new signature is stored at compromised message signature store 225.

While message indicators of compromise analysis module 213 can be used to analyze incoming messages, the threat detection analysis can also be performed retrospectively. For example, previously received messages can be analyzed to determine if past messages should be revised and identified as suspicious with an appropriate security classification. In various embodiments, retrospective inspection can utilize a lookback window. For example, any messages received within the lookback window are analyzed but messages older than and outside the lookback window are not analyzed and do not require review. The use of a lookback window allows the retrospective analysis to be contained to an appropriately limited set of previously reviewed messages. In some embodiments, the previously received messages are received from message store 223. In some embodiments, only the required indicators of the previously received messages are retrieved. For example, the retrospective analysis can be performed with only the retrieved indicators of previously received messages, thereby limiting the amount of message data that must be stored and retrieved.

In some embodiments, when a new threat is detected, a forward window is created for the analysis of future messages. For example, a time-to-live (TTL) value can be created for new threats and associated with tracked indicators of compromise signatures. The use of a TTL extends the active life of the threat while also limiting the threat to a window of time in the future, such as 1 hour, 3 days, 1 week, 1 month, 3 months, or another appropriate value. For example, IP addresses are often dynamically assigned and are often released and reassigned to a different entity. In various embodiments, when a threat utilizes a sender IP address indicator, a corresponding TTL can be assigned based on the appropriate span covering the valid life of an IP address. In contrast, for a threat with a malicious link, a longer TTL can be assigned since the link will likely remain malicious for the foreseeable future and is unlikely to be reclaimed and used as a valid and safe link.

In some embodiments, message machine learning (ML) scoring module 215 is a processing module for scoring a message to determine whether the message is a threat. For example, each received message can be scored by message ML scoring module 215 to determine a threat score. The threat score can be evaluated against a security threshold to determine if the corresponding message is suspicious and a potential security threat (such as a malicious message). In various embodiments, based on the ML scoring result, a security classification is determined. The determined security classification can include corresponding warning messages and remediation actions to mitigate an identified threat.

In some embodiments, message ML scoring module 215 can make use of heuristics, rules, neural networks, or other trained ML algorithms that rely on decision trees (e.g., gradient-boosted decision trees), logistic regression, or linear regression. Accordingly, message ML scoring module 215 may produce discrete outputs or continuous outputs, such as a probability metric (e.g., specifying the likelihood that a message is suspicious), a binary output (e.g., malicious or not malicious, or suspicious or not suspicious), or a classification (e.g., specifying the type of security classification for a message).

In some embodiments, training module 217 is a processing module for training models for message threat detection. In some embodiments, training module 217 operates to train the models employed by the other modules such as to train the machine learning (ML) model(s) employed by message ML scoring module 215. For example, if remediation module 219 and/or reporting module 221 are designed to apply ML model(s), training module 217 can train the respective ML model(s) by feeding training data into their respective ML model(s). The training data can include message indicator data for suspicious messages as identified by message indicators of compromise analysis module 213. The training data may be employee-or enterprise-specific so that the ML model(s) are able to perform personalized analysis. In some embodiments, the training data ingested by the ML model(s) includes suspicious messages and their corresponding message indicators used to define an indicators of compromise signature.

Moreover, training module 217 may implement a retraining pipeline (or simply “pipeline”) in order to protect against novel threats including newly identified threats. At a high level, the pipeline may be representative of a series of steps that, when executed by training module 217, cause the models employed by message ML scoring module 215 to be retrained. By consistently training the models using up-to-date information, threat detection service with compromise detection consistency 201 can protect against novel threats that would otherwise escape detection and help enforce compromise detection consistency as new threats are identified. For example, newly identified threats by message indicators of compromise analysis module 213 can be used by training module 217 for retraining. The retraining data can include the message data and associated indicators of compromise.

In some embodiments, remediation module 219 is a processing module for performing remediation for a detected security threat associated with a message identified as suspicious. For example, based on tracked message indicators of compromise signatures and/or a determined ML model result, remediation module 219 can initiate one or more different security actions for a particular message based on the message's determined security classification. In some embodiments, remediation module 219 may utilize reporting module 221 to provide remediation results for performed or pending security actions.

In some embodiments, reporting module 221 is a processing module for providing reports on threat detection results including insights on messages identified as suspicious and potential security threats. In some embodiments, reporting module 221 provides reports derived from the outputs that are produced by message indicators of compromise analysis module 213, message ML scoring module 215, and/or remediation module 219. For example, reporting module 221 may provide a summary of message threats belonging to the same attack campaign discovered by matching message indicators to tracked indicators of compromise signatures. The reported information, including summary and/or surfaced insights into threats, can be provided in a human-readable format. Other reporting information can be provided as well including details, summaries, and insights on messages belonging to the same security threat and their corresponding message indicators of compromise, such as a sender IP address, subject, and message-id. In some embodiments, reporting module 221 provides an interactive user interface for examining threat results such as an interactive online dashboard.

In some embodiments, message store 223 and compromised message signature store 225 are a collection of one or more data stores used by the different modules of threat detection service with compromise detection consistency 201. Message store 223 can store a version of each message analyzed by threat detection service with compromise detection consistency 201. By storing a message, retrospective analysis can be performed. For example, a stored message can be retrieved at a later date, such as when new threats are identified, and analyzed to determine whether the previously received message meets the newly identified criteria to belong to the newly identified threat. In some embodiments, the messages are stored using a compressed version of the message such as a digest version of the message. In some embodiments, the messages are stored by storing the values of extracted message indicators along with additional message metadata. In connection with message store 223, compromised message signature store 225 is used to store signatures of messages identified as suspicious along with their corresponding security classifications. For example, known indicators of compromise signatures can be tracked and stored in compromised message signature store 225 and used to determine whether a match exists with indicators of a message being analyzed.

In some embodiments, one or more data stores exist (but may not be shown in FIG. 2) that store additional configuration and processing data such as messaging service configuration data, machine learning model data, and/or remediation data. For example, data stores can exist that are used to store account information including the different messaging services and their messaging accounts that have been configured for threat detection. As another example, data stores can be used to store administrative and/or account credentials for interfacing with different messaging service platforms such as credentials and configuration settings required for ingesting messages from a message service. The data stores can be further used to store security metrics, analytics, and reports including detected security threats and corresponding remediation results. Although not shown in FIG. 1, the data stores may be implemented with distributed data stores such as one or more distributed data stores accessed.

In some embodiments, one or more of the components of threat detection service with compromise detection consistency 201 may be implemented individually while operating “alongside” threat detection service with compromise detection consistency 201. For example, reporting module 221 may be implemented in a remote computing environment to which threat detection service with compromise detection consistency 201 is communicatively connected across a network. In various embodiments, threat detection service with compromise detection consistency 201 may be implemented by a security service on behalf of an enterprise or the enterprise itself. In some embodiments, aspects of threat detection service with compromise detection consistency 201 are accessible or interactable via a web-accessible computer program operating on a computer server or a distributed computing system. For example, an individual may be able to interface with threat detection service with compromise detection consistency 201 through a web browser that is executing on an electronic computing device (also called an “electronic device” or “computing device”).

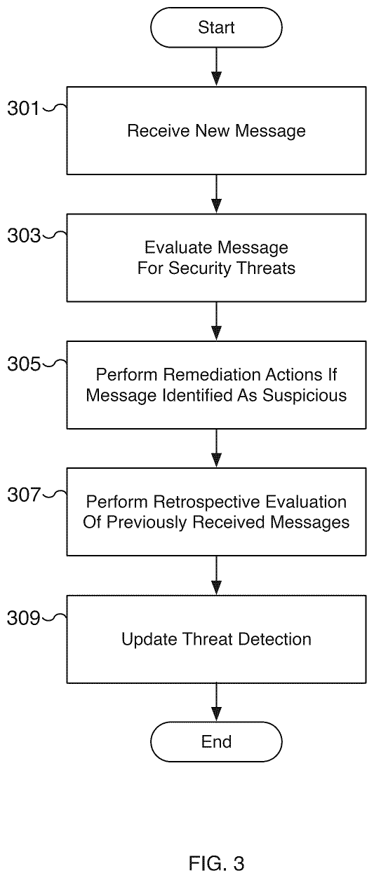

FIG. 3 is a flow chart illustrating an embodiment of a process for performing threat detection that maintains consistency in threat detection outcomes. For example, using the process of FIG. 3, a threat detection service can detect potential threats posed by messages while enforcing consistency in compromise detection outcomes. When enforcing consistent outcomes, messages that are the same, similar, and/or related, such as messages that are part of the same attack campaign, are grouped with the same security classification. The shared grouping allows for the same warning messages to be presented and the same remediation actions to be suggested and performed, removing inconsistency in threat detection outcomes. In the event a new threat is detected, retrospective message analysis can be performed on previously received messages to determine whether any of the older messages should be grouped as part of the new threat. Similarly, details of the new threat can be used to update threat detection to more easily identify the new threat via additional threat detection pipelines such as threat detection workflows that utilize machine learning. The results from the threat detection analysis performed can be made available, for example, as reports or via an interactive dashboard. In some embodiments, the process of FIG. 3 is performed by a threat detection service with compromise detection consistency such as threat detection service with compromise detection consistency 141 of FIG. 1 and/or threat detection service with compromise detection consistency 201 of FIG. 2. In some embodiments, the messages analyzed for threats are hosted by a messaging service such as messaging service 131 of FIG. 1.

At 301, a new message is received. For example, an incoming (or outgoing) message is received for a user with threat detection monitoring enabled. The message can be received directly from the user client, such as via the user's messaging application and/or via the messaging service or platform. Depending on the messaging service and its available integration features, the format and technique for ingesting the message may differ. In various embodiments, the received message includes the entire message and may include metadata for the message such as message headers, IP addresses, and sender and receiver information, among other data. In some embodiments, the received message includes additional context such as the user account and related groups to which the user belongs, access permissions assigned to the user, user configuration settings, past user behavior and interactions, and/or behavior and interactions of related users such as other users belonging to the same groups or enterprises and/or from the same regions or locations. The context data received can also include data from related messages or messaging systems, such as user data for the same user but from another messaging system. Other data including message and user metadata may also be received.

In some embodiments, the new message received is a message that was previously analyzed and/or a digest version of the message. For example, instead of receiving the message in its entirety, indicators of the message that, when taken together, are a representation of the message required for threat detection are received. The indicators can correspond to message headers, digests of attachments, components of message headers, etc. For example, an email address can be received and/or a component of an email address can be received, such as an FQDN or an RDN of an email address. In various embodiments, the received indicators can include components and/or fields of the message such as the message's message-id, message group ID, IP address, subject, sender, reply-to, links, and attachments, among others including other message header fields.

At 303, the message is evaluated for security threats. For example, the message received at 301 (or a version of the message received) is evaluated for potential security threats. In some embodiments, a determination is made whether the message is suspicious. For example, a message identified as suspicious has the potential to be malicious and may introduce a security threat. When a message is identified as suspicious, one or more security actions can be taken to mitigate the potential threats including by performing remediation actions. Each suspicious message can be assigned a security classification, such as a security group or category that corresponds to the type of threat and how to address the identified threat. For example, a security classification may include the appropriate warning messages to provide and the appropriate security actions that need to be performed to mitigate security risks posed by the message.

In some embodiments, the evaluation of a message for security threats can be performed by one or more threat detection pipelines. For example, a machine learning approach can be used to apply trained machine learning models to evaluate a message. In addition to the ML approach, an indicators of compromise or rules-based systems approach can be applied as well. By matching indicators of the message received at 301 to tracked indicators of compromise signatures, a message can be identified as suspicious and/or linked to known threats. In some embodiments, the two threat detection pipelines can work together, may have overlapping coverage, and can expand the threat detection coverage. For example, an indicators of compromise approach is able to quickly identify new threats without requiring extensive and potentially expensive retraining needed for an ML approach. When used together with other threat detection approaches (such as an ML approach), the indicators of compromise approach allows for consistency in compromise detection. In some embodiments, the indicators of compromise approach is implemented as a full consistency solution, where messages that match the same indicators have the same detection outcomes. In contrast, in some embodiments, the indicators of compromise are used to implement a partial consistency solution. With a partial consistency solution, the indicators can be used to improve the existing threat detection analysis, such as to improve an ML model used for threat detection. As a result, with a partial consistency solution, it is possible that only a subset of the messages that share the same indictors of compromise signatures have the same detection outcome.

At 305, remediation actions are performed if the message is identified as suspicious. In the event the message is identified as suspicious, one or more remediation actions are performed to mitigate the threat presented by the message. The remediation actions can include security actions such as providing warning messages, providing security reports or updates, and initiating changes to the corresponding messaging system to improve security. For example, the message can be quarantined, and warning instructions can be provided to the user on how to safely address the message. Other remediation actions such as requiring a password reset, disabling incoming email, notifying a security administrator, raising security requirements for related accounts, etc. can also be performed.

At 307, a retrospective evaluation of previously received messages is performed. For example, a review of previously received messages can be optionally initiated based on a trigger event such as a newly identified security threat. In some scenarios, a message identified as suspicious triggers the identification of a new security threat, such as a new security threat that is part of a newly identified attack campaign. When a new security threat is identified, past messages can be reviewed to identify earlier messages that are also part of a coordinated attack. The security classification of the previously received messages can be revised if found to belong to be part of the newly identified security threat. In some embodiments, the retrospective evaluation is performed by comparing indicators of previously received messages to the indicators of compromise signature of the newly identified security threat. The retrospective evaluation may utilize a lookback window to limit the number of previously received messages to evaluate.

At 309, threat detection is updated. For example, one or more threat detection pipelines may be revised and updated to improve the accuracy of threat detection outcomes and to maintain threat detection outcome consistency between different threat detection pipelines. In some embodiments, the threat detection is updated with newly identified threats including by training or retraining machine learning models used to evaluate messages for security threats. For example, new security threats identified using an indicators of compromise approach can be used to train and improve a machine learning approach that functions alongside the indicators of compromise approach. The machine learning models can be retrained using training data composed of the indicators of new messages, the tracked indicators of compromise signatures, and/or their corresponding tracked security classifications. In some embodiments, this approach corresponds to a partial consistency solution. Since the indicators are used as one of potentially many inputs to improve and update threat detection, when threat detection is performed, messages that share the same indictors of compromise signatures may have different outcomes. In some embodiments, the indicators of compromise signatures of new security threats are tracked and used to identify the same threat in future messages. An indicators of compromise signature may be associated with a forward-looking window such as via a time-to-live (TTL) value. For example, a forward-looking window can be utilized to configure how long to continue looking for matches to a particular indicators of compromise signature.

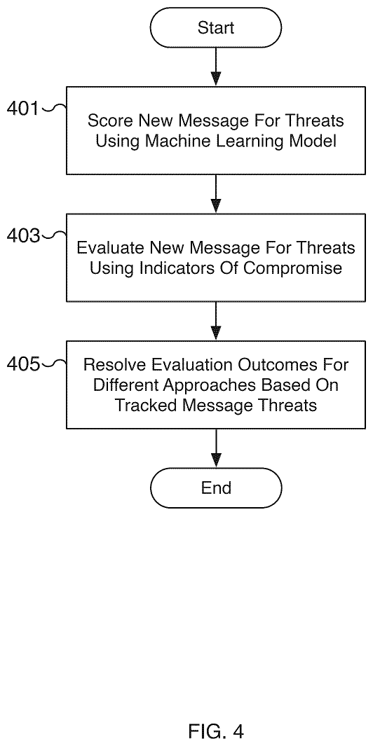

FIG. 4 is a flow chart illustrating an embodiment of a process for identifying a message that poses as a security threat and initiating remediation actions. For example, using the process of FIG. 4, a threat detection service can utilize two approaches for identifying security threats in a message and reconcile the outcome of the different approaches to maintain consistency evaluation results. In some embodiments, a first approach utilizes an indicators of compromise or rules-based systems approach and a second approach applies a machine learning approach. By utilizing both approaches together, the threat detection system can have expanded threat detection coverage and maintain compromise detection consistency. in some embodiments, indicators of compromise signatures are used to enforce consistency in threat detection outcomes by matching indicators of messages identified as suspicious by the ML approach to previously identified threats. In some embodiments, the process of FIG. 4 is performed at 301 and/or 303 of FIG. 3 by a threat detection service with compromise detection consistency such as threat detection service with compromise detection consistency 141 of FIG. 1 and/or threat detection service with compromise detection consistency 201 of FIG. 2. In some embodiments, the messages analyzed for threats are hosted by a messaging service such as messaging service 131 of FIG. 1.

At 401, the new message is scored for threats using a machine learning model. For example, using an ML approach, a message is evaluated to identify potential security threats. In some embodiments, an ML model is used to predict one or more threat scores and the prediction results are evaluated against one or more thresholds. When a message is identified as suspicious based on the ML result, the message is assigned a corresponding security classification associated with a known security threat or attack. In some scenarios, the same or a similar message that was previously evaluated may have a different security classification resulting in inconsistent threat assessment outcomes over time. This inconsistency is resolved by performing a second threat detection approach at 403 and aligning the threat assessment outcomes with past outcomes at 405.

At 403, the new message is evaluated for threats using indicators of compromise. For example, an indicators of compromise approach using indicators of compromise signatures to match messages to previously identified threats is performed. By extracting indicators of the new message, the extracted indicators can be evaluated against indicators of compromise signatures for messages with known threats and associated security classifications. When a match is found, the new message is identified as a suspicious message that matches a previously identified threat. The new message may be assigned the security classification of the matching signature. For example, if the message is not flagged as suspicious at step 401, the message is assigned the security classification of the matching signature. In the event the message is flagged as suspicious at 401, the evaluation outcomes for the different approaches are resolved at 405.

At 405, the evaluation outcomes for different approaches are resolved based on tracked message threats. For example, when a message is identified as suspicious at 401 using the ML approach and also matches a tracked indicators of compromise signature at 403, the security classification of the message is revised to use the security classification associated with the message of the tracked indicators of compromise signature. The inconsistency is thus resolved in favor of the security classification of the tracked message as defined by the indicators of compromise signature. By revising the message to match previous assessment outcomes, the outcome results are aligned over time and threat detection outcome inconsistencies are resolved.

In some embodiments, the inconsistent evaluation outcomes are resolved by applying a consensus resolution process. The consensus resolution can evaluate the different outcomes and select a single decision to apply across all messages matching the same signature. Different approaches and configurations can be used for the consensus resolution process. For example, a most common decision approach can be taken that applies the most common outcome to all messages matching the same signature. In some embodiments, the selected outcome is based on the severity of the threat. For example, a most malicious decision, least malicious decision, average malicious decision, or another selection based on the severity of the threat can be used for the consensus resolution process. In some embodiments, the most malicious decision of the different outcomes is applied across all messages matching the same signature. Other approaches can be applied as well. For example, a most recent decision can be applied across all messages matching the same signature.

In some embodiments, the approach utilized for the consensus resolution process can be configured and can be customized depending on the desired outcome such as to maximize customer safety, to minimize the different types of message remediation actions, etc. For example, the consensus resolution process can be configured using a consensus resolution configuration. Different configuration settings can be used depending on the desired outcome. For example, a security administrator can configure the consensus resolution process to select an updated security classification based on an evaluation on the threat severities between different security classifications. The evaluation can be based on the differences in outcomes, the suggested remediation measures, the impact of the suggested remediation measures, and/or the cost of implementing the remediation measures, among other factors. For example, a most malicious decision, least malicious decision, average malicious decision, or another selection based on the severity of the threat can be used for the consensus resolution process.

In some embodiments, only one of the two evaluation approaches performed at 401 and 403 will identify a message as a potential threat and the security classification of the approach used to flag the message as a potential threat is used. On subsequent updates to the threat detection system, the different approaches can include improved ML models and additional indictors of compromise signatures that can result in both approaches identifying the threat. In some embodiments, neither of the two evaluation approaches performed at 401 and 403 will identify a message as a potential threat, resulting in the message being treated as a safe message. The message may be stored and the security classification may be revised in the future during a retrospective analysis of the message.

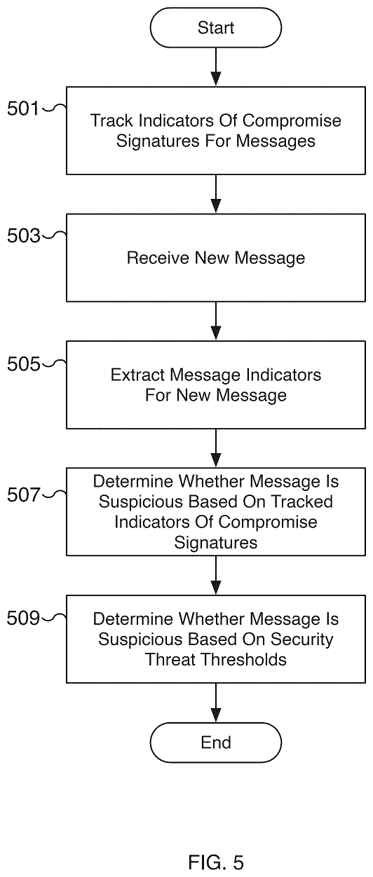

FIG. 5 is a flow chart illustrating an embodiment of a process for identifying a message that poses as a security threat using message indicators. For example, using the process of FIG. 5, a threat detection system can identify messages that are suspicious by comparing indicators of the message to indicators of compromise signatures associated with tracked suspicious messages. Further, by evaluating a message using indicators, new threats can be detected and tracked based on security threat thresholds. In some embodiments, the process of FIG. 5 is performed at 301 and/or 303 of FIG. 3 and/or at 403 of FIG. 4 by a threat detection service with compromise detection consistency such as threat detection service with compromise detection consistency 141 of FIG. 1 and/or threat detection service with compromise detection consistency 201 of FIG. 2. In some embodiments, the messages analyzed for threats are hosted by a messaging service such as messaging service 131 of FIG. 1.

At 501, indicators of compromise signatures are tracked for messages. For example, for compromised messages such as suspicious messages and/or messages that are potential security threats, indicators of compromise signatures are tracked. The tracked signatures are a set of indicators of a compromised message. The exact number of indicators in a signature may differ depending on type of threat. Example indicators of compromise can include components or fields of a compromised message such as a compromised message's message-id (or Internet Message ID or IMID), message group ID, Internet Protocol (IP) address, and subject. Additional indicators of compromise can include message sender, reply-to, links, and attachments, among others including other message header fields. In some embodiments, the values stored for the indicators of compromise may be digest or compressed values such as a digest of a malicious attachment rather than storing the entire email attachment. In some embodiments, the sender and/or reply-to indicators of compromise can include relative domain name (RDN), fully qualified domain name (FQDN), and email components.

In various embodiments, the indicators of compromise signatures are stored in a compromised message signature store such as compromised message signature store 255 of FIG. 2. The tracked signatures can be signatures automatically identified by the threat detection system, such as by exceeding configured threshold values for a denial of service attack. In some embodiments, the signatures are provided by users such as by end users, security administrators, and/or third-party users or services. For example, a user can provide an indicators of compromise for generating an indicators of compromise signature by providing a set of indicators for a received suspicious messages such as a message sender email and subject pair.

At 503, a new message is received. For example, an incoming (or outgoing) message is received for a user with threat detection monitoring enabled. Depending on the messaging service and its available integration features, the format and technique for ingesting the message may differ. In various embodiments, the received message includes the entire message and may include metadata for the message such as message headers, IP addresses, and sender and receiver information, among other data. In some embodiments, the new message received is a message that was previously analyzed and/or a digest version of the message. For example, instead of receiving the message in its entirety, indicators of the message that, when taken together, are a representation of the message required for threat detection are received.

At 505, message indicators are extracted for the new message. For example, indicators of a message required for comparing to indicators of compromise signatures are extracted for the new message. In various embodiments, the indicators extracted can include components or fields of a message such as a message's message-id, message group ID, IP address, subject, sender, reply-to, links, and attachments, among others including other message header fields. In some embodiments, the extracted indicators may be extracted as digest or compressed values such as a digest of an attachment rather than an entire email attachment. In some embodiments, the extracted indicators are components of the message or components of message fields. For example, the sender and/or reply-to indicators can include relative domain name (RDN), fully qualified domain name (FQDN), and email components.

At 507, a determination is made whether the message is suspicious based on the tracked indicators of compromise signatures. For example, the message indicators extracted at 505 are compared against the indicators of compromise signatures tracked at 501. In some embodiments, the matching is done by determining the correct set of message indicators to compare against for each tracked indicators of compromise signature. In some embodiments, a match is found using exact matches. For certain indicators, such as a message subject field, non-exact matches including fuzzy matches, partial or full keyword matches, regular expression matches, etc. may also be appropriate. In the event the indicators of the message are found to match a tracked indicators of compromise signature, a determination is made that the message is suspicious and a potential security threat. In various embodiments, a suspicious message is also assigned the security classification associated with the found matching signature, thereby grouping the new message with previous threat detection outcomes of the same security classification.

At 509, a determination is made whether the message is suspicious based on security threat thresholds. For example, as new messages are received and evaluated, tracked message counts such as message and property-based counts can exceed configured security threat threshold values indicating that a new security threat, such as a new denial of service threat, has been identified. As another example, in the event a burst of messages is received from a new sender originating from a location where an enterprise has no presence, the first few messages will not trigger a new security threat. As the number of messages received with the same matching indicators signature increases, the likelihood that the set of messages is a security threat also increases. In various embodiments, configured threat thresholds can be set for evaluating and triggering the detection of a new security threat. For example, when an indicator threat threshold is exceeded, the threat detection system can determine that a new security threat is detected and that the corresponding message is suspicious and a potential security threat. The message is determined to be a compromised message, and its indicators of compromise are determined and used to generate a corresponding indicators of compromise signature. The generated indicators of compromise signature can be used to identify new messages as matching the same security threat and a retrospective inspection of previously evaluated messages can be performed to identify past messages and recategorize them as matching the same security threat.

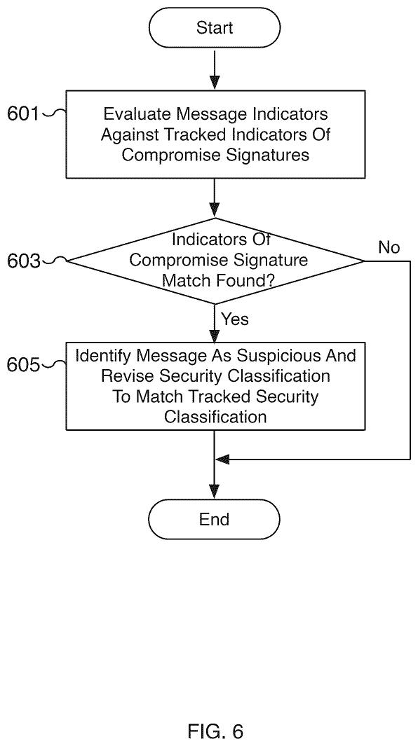

FIG. 6 is a flow chart illustrating an embodiment of a process for identifying a message as a security threat using indicators of compromise signatures. For example, using the process of FIG. 6, a threat detection system can identify messages that are suspicious by comparing extracted indicators of the message to indicators of compromise signatures associated with tracked suspicious messages. In some embodiments, the process of FIG. 6 is performed at 301 and/or 303 of FIG. 3, at 403 of FIG. 4, and/or at 507 of FIG. 5 by a threat detection service with compromise detection consistency such as threat detection service with compromise detection consistency 141 of FIG. 1 and/or threat detection service with compromise detection consistency 201 of FIG. 2. In some embodiments, the messages analyzed for threats are hosted by a messaging service such as messaging service 131 of FIG. 1.

At 601, message indicators are evaluated against tracked indicators of compromise signatures. For example, indicators extracted from a message are compared against tracked signatures composed of indicators of compromise for known suspicious messages. In some embodiments, the tracked indicators of compromise signatures are retrieved from a compromised message signature store. The indicators of a message including the indicators of compromise can correspond to components or fields of a message such as a message's message-id, message group ID, IP address, subject, sender, reply-to, links, and attachments, among others including other message header fields. For certain indicators, the indicator value can be a digest value such as a digest of a message attachment rather than the full attachment. Similarly, some indicators correspond to components of a message property such as an RDN or FQDN of a corresponding email address. The indicators of a message match a compromised signature when the message indicators match the tracked indicators of compromise of a compromised message. In some embodiments, a complete match is required although alternative matching schemes can be utilized as well including fuzzy matching schemes, partial matching schemes, and logic-based matching schemes, among others. For example, fuzzy matching schemes can be used for message subjects allowing subject indicator matches when a non-substantive difference exists between two subjects.

At 603, a determination is made whether a match to an indicators of compromise signature match is found. In the event a match is found, a suspicious message has been identified, and processing proceeds to 605. In the event a match is not found, processing completes.

At 605, the message is identified as suspicious and its security classification is revised to match the tracked security classification. For example, a match is found when comparing the message indicators to tracked indicators of compromise signatures. Since the message's indicators match those of a compromised message, the message is identified as suspicious. Moreover, the message is assigned a security classification associated with the matching signature and its corresponding compromised message. By aligning the security classification of the message to known compromised messages, compromise detection consistency is enforced. In some embodiments, a time-to-live value is checked before the message is identified as suspicious and a corresponding security classification is assigned. In various embodiments, a time-to-live value associated with the tracked indicators of compromise signature is updated over time, for example, to eventually close the forward-looking window associated with detecting the particular type of security threat.

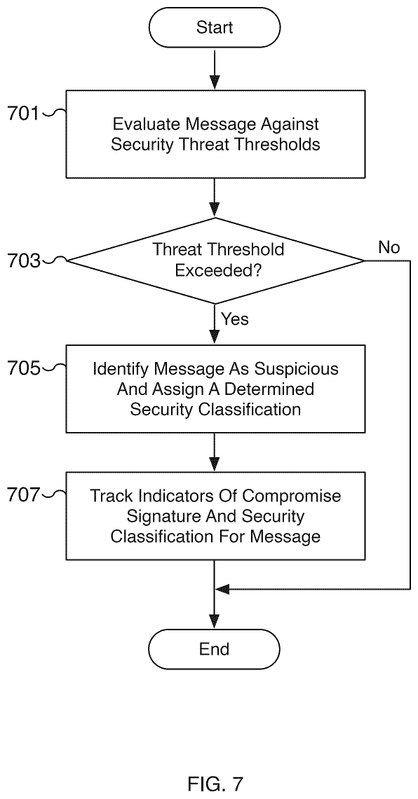

FIG. 7 is a flow chart illustrating an embodiment of a process for identifying a new security threat using a message threat threshold. For example, using the process of FIG. 7, a threat detection system can identify messages that are suspicious and the associated new security threat by tracking message-based counts against message-based threat thresholds values. When message-based threat threshold values are exceeded, a new security threat is identified and the corresponding message triggering the identification is determined to be suspicious. The suspicious message is used to generate an indicators of compromise signature for identifying other messages of the same security threat. In some embodiments, the indicators of compromise signature is tracked and stored in a compromised message signature store. In some embodiments, the process of FIG. 7 is performed at 301 and/or 303 of FIG. 3, at 403 of FIG. 4, and/or at 509 of FIG. 5 by a threat detection service with compromise detection consistency such as threat detection service with compromise detection consistency 141 of FIG. 1 and/or threat detection service with compromise detection consistency 201 of FIG. 2. In some embodiments, the messages analyzed for threats are hosted by a messaging service such as messaging service 131 of FIG. 1. In some embodiments, the compromised message signature store is compromised message signature store 225 of FIG. 2.

At 701, a message is evaluated against security threat thresholds. For example, as messages are received and evaluated, tracked message counts such as message and property-based counts are updated and compared against configured security threat thresholds. In some embodiments, different types of security threat thresholds can be configured such as a security threat threshold for identifying different types of security threats. For example, a security threat threshold for detecting a denial of service (DOS) attack may differ from a security threat threshold for detecting a targeted phishing attack.

At 703, a determination is made whether a threat threshold value is exceeded. In the event a threat threshold value is exceeded, processing proceeds to 705. In the event a threat threshold value is not exceeded, processing completes.

At 705, the message is identified as suspicious and assigned a determined security classification. For example, by exceeding a threat threshold value at 703, the message evaluated at 701 is identified as suspicious and a new potential security threat. The message is determined to be a compromised message, and it is assigned an appropriate security classification. As an instance of a new security threat, the compromised message will have properties that are unique to itself allowing subsequently analyzed messages that are identified as part of the same threat to be grouped in the same security classification.

At 707, an indicators of compromise signature and corresponding security classification are tracked for the message. For example, the detected compromised message is used to generate an indicators of compromise signature for identifying similarly compromised messages in the future. The indicators extracted from the message are used to determine a set representative of the compromised signature and properties of the newly detected security threat. In some embodiments, the message indicators are evaluated to identify the appropriate set of indicators of compromise by analyzing the properties and/or behavior of the newly detected security threat. The new message can also be compared against previously analyzed messages to identify signature and/or outlier properties and behaviors. Once generated, the indicators of compromise signature is tracked and stored such as in a compromised message signature store. Along with the tracked signature, the assigned security classification of the compromised message is also tracked such that when future messages are found to match the tracked signature, they can also be assigned the corresponding security classification of the tracked message signature. In various embodiments, the generated and tracked indicators of compromise signature can be later retrieved and used to identify newly received messages as belonging to the same security threat and to perform a retrospective inspection of previously evaluated messages to recategorize them as belonging to the same security threat.

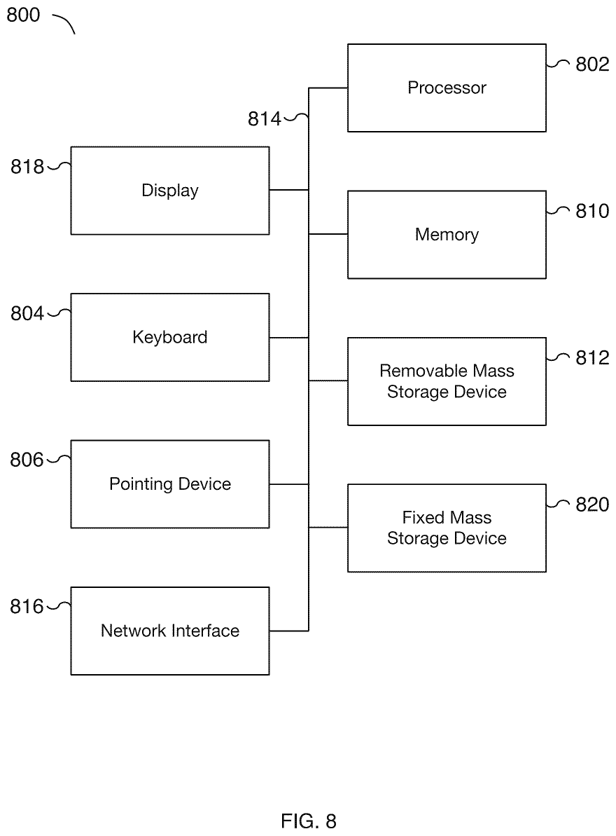

FIG. 8 is a functional diagram illustrating a programmed computer system for performing threat detection that maintains consistency in threat detection outcomes. As will be apparent, other computer system architectures and configurations can be utilized for the detection of security threats while maintaining compromise detection consistency. Examples of computer system 800 include clients 101, 103, and 105 of FIG. 1 and/or one or more computers of messaging service 131 of FIG. 1, threat detection service with compromise detection consistency 141 of FIG. 1, and/or threat detection service with compromise detection consistency 201 of FIG. 2. Computer system 800, which includes various subsystems as described below, includes at least one microprocessor subsystem (also referred to as a processor or a central processing unit (CPU)) 802. For example, processor 802 can be implemented by a single-chip processor or by multiple processors. In some embodiments, processor 802 is a general purpose digital processor that controls the operation of the computer system 800. Using instructions retrieved from memory 810, the processor 802 controls the reception and manipulation of input data, and the output and display of data on output devices (e.g., display 818). In various embodiments, one or more instances of computer system 800 can be used to implement at least portions of the processes of FIGS. 3-7.

Processor 802 is coupled bi-directionally with memory 810, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also as is well known in the art, primary storage typically includes basic operating instructions, program code, data and objects used by the processor 802 to perform its functions (e.g., programmed instructions). For example, memory 810 can include any suitable computer-readable storage media, described below, depending on whether, for example, data access needs to be bi-directional or unidirectional. For example, processor 802 can also directly and very rapidly retrieve and store frequently needed data in a cache memory (not shown).

A removable mass storage device 812 provides additional data storage capacity for the computer system 800, and is coupled either bi-directionally (read/write) or unidirectionally (read only) to processor 802. For example, storage 812 can also include computer-readable media such as magnetic tape, flash memory, PC-CARDS, portable mass storage devices, holographic storage devices, and other storage devices. A fixed mass storage 820 can also, for example, provide additional data storage capacity. The most common example of mass storage 820 is a hard disk drive. Mass storages 812, 820 generally store additional programming instructions, data, and the like that typically are not in active use by the processor 802. It will be appreciated that the information retained within mass storages 812 and 820 can be incorporated, if needed, in standard fashion as part of memory 810 (e.g., RAM) as virtual memory.

In addition to providing processor 802 access to storage subsystems, bus 814 can also be used to provide access to other subsystems and devices. As shown, these can include a display monitor 818, a network interface 816, a keyboard 804, and a pointing device 806, as well as an auxiliary input/output device interface, a sound card, speakers, and other subsystems as needed. For example, the pointing device 806 can be a mouse, stylus, track ball, or tablet, and is useful for interacting with a graphical user interface.

The network interface 816 allows processor 802 to be coupled to another computer, computer network, or telecommunications network using a network connection as shown. For example, through the network interface 816, the processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect the computer system 800 to an external network and transfer data according to standard protocols. For example, various process embodiments disclosed herein can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

An auxiliary I/O device interface (not shown) can be used in conjunction with computer system 800. The auxiliary I/O device interface can include general and customized interfaces that allow the processor 802 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 8 is but an example of a computer system suitable for use with the various embodiments disclosed herein. Other computer systems suitable for such use can include additional or fewer subsystems. In addition, bus 814 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
tracking indicators of compromise signatures of previously received messages in a data storage;
receiving a new message having indicators;
using a machine learning model to determine whether the new message is suspicious;
based on a result of the machine learning model for the new message, assigning the new message a security classification;
searching the data storage to determine whether the indicators of the new message match any of the tracked indicators of compromise signatures determined to be suspicious; and
revising the security classification of the new message to match a tracked security classification of a previously received message having a matching tracked indicators of compromise signature with the new message.

2. The method of claim 1, wherein the indicators of the new message correspond to one or more values associated with: a message-id, a message group ID, an IP address, a subject, a sender, a reply-to, or an attachment.

3. The method of claim 1, wherein at least one indicator of the indicators of the new message is a digest version of a component of the new message.

4. The method of claim 3, wherein the component of the new message corresponds to an attachment of the new message.

5. The method of claim 1, further comprising retraining the machine learning model using the indicators of the new message, the tracked indicators of compromise signature, or the tracked security classification.

6. The method of claim 1, further comprising updating a time-to-live value associated with the tracked indicators of compromise signatures.

7. The method of claim 1, further comprising: storing the indicators of the new message.

8. The method of claim 1, based on a consensus resolution configuration, updating the tracked security classification of the previously received message having the matching tracked indicators of compromise signature with the new message.

9. The method of claim 8, wherein the consensus resolution configuration is utilized to select an updated security classification based on an evaluation of threat severities between different security classifications.

10. A system, comprising:
one or more processors; and
a memory coupled to the one or more processors, wherein the memory is configured to provide the one or more processors with instructions which when executed cause the one or more processors to:
track indicators of compromise signatures of previously received messages in a data storage;
receive a new message having indicators;
using a machine learning model, determine whether the new message is suspicious;
based on a result of the machine learning model for the new message, assign the new message a security classification;
search the data storage to determine whether the indicators of the new message match any of the tracked indicators of compromise signatures determined to be suspicious; and
revise the security classification of the new message to match a tracked security classification of a previously received message having a matching tracked indicators of compromise signature with the new message.

11. The system of claim 10, wherein the indicators of the new message correspond to one or more values associated with: a message-id, a message group ID, an IP address, a subject, a sender, a reply-to, or an attachment.

12. The system of claim 10, wherein at least one indicator of the indicators of the new message is a digest version of a component of the new message.

13. The system of claim 12, wherein the component of the new message corresponds to an attachment of the new message.

14. The system of claim 10, wherein the memory is further configured to provide the one or more processors with instructions which when executed cause the one or more processors to:
retrain the machine learning model using the indicators of the new message, the tracked indicators of compromise signature, or the tracked security classification.

15. The system of claim 10, wherein the memory is further configured to provide the one or more processors with instructions which when executed cause the one or more processors to:
update a time-to-live value associated with the tracked indicators of compromise signatures.

16. The system of claim 10, wherein the memory is further configured to provide the one or more processors with instructions which when executed cause the one or more processors to:
store the indicators of the new message.

17. The system of claim 10, wherein the memory is further configured to provide the one or more processors with instructions which when executed cause the one or more processors to:
based on a consensus resolution configuration, update the tracked security classification of the previously received message having the matching tracked indicators of compromise signature with the new message.

18. The system of claim 17, wherein the consensus resolution configuration is associated with selecting an updated security classification based on an evaluation of threat severities between different security classifications.

19. A method, comprising:
receiving a new message having indicators;
tracking message counts associated with receiving the new message;
comparing the tracked message counts against one or more security threat thresholds; and
in response to at least one of the tracked message counts exceeding at least one of the one or more security threat thresholds:
identifying a new security threat, wherein the new security threat is assigned a security classification;
assigning the security classification to the new message; and
generating an indicators of compromise signature based on the new message.

20. The method of claim 19, further comprising:
initiating a retrospective analysis of previously received messages using the indicators of compromise signature generated based on the new message;
identifying a match message among the previously received messages to the indicators of compromise signature generated based on the new message; and
revising a security classification of the matching message to the security classification of the new message.
